(19) United States
(12) Patent Application Publication
(10) Pub. No.: US 2025/0199244 A1
(43) Pub. Date: Jun. 19, 2025

(54) OPTICAL ASSEMBLY, OPTICAL CHIP, ELECTRONIC DEVICE, AND OPTICAL COMMUNICATION SYSTEM

(71) Applicant: HUAWEI TECHNOLOGIES CO., LTD., Shenzhen (CN)

(72) Inventors: Pengcheng XIAO, Wuhan (CN); Xueming ZHANG, Wuhan (CN); Wenqi ZHANG, Gent (BE); Meng WANG, Shenzhen (CN)

(21) Appl. No.: 19/064,298

(22) Filed: Feb. 26, 2025

Related U.S. Application Data
(63) Continuation of application No. PCT/CN2023/102223, filed on Jun. 25, 2023.

(30) Foreign Application Priority Data
Sep. 1, 2022 (CN) 202211067447.1

(51) Int. Cl. G02B 6/30

(52) U.S. Cl. CPC G02B 6/30

(57) ABSTRACT

An optical assembly is provided, including: a fiber array unit including a base plate and a plurality of optical fibers located on a surface of the base plate, where the plurality of optical fibers have optical fiber end faces, and a plane on which the optical fiber end faces are located is not perpendicular to a plane on which the surface of the base plate is located; and an optical chip including a substrate and a waveguide layer, where the substrate has a substrate end face, the waveguide layer is formed on a surface of the substrate, the waveguide layer has a waveguide end face, the substrate end face and the waveguide end face are at a non-zero included angle.

### CROSS-REFERENCE TO RELATED APPLICATIONS

This application is a continuation of International Application No. PCT/CN2023/102223, filed on Jun. 25, 2023, which claims priority to Chinese Patent Application No. 202211067447.1, filed on Sep. 1, 2022. The disclosures of the aforementioned applications are hereby incorporated by reference in their entireties.

### TECHNICAL FIELD

This application relates to the field of communication technologies, and in particular, to an optical assembly, an optical chip, an electronic device, and an optical communication system.

### BACKGROUND

Continuous growth of global data communication promotes continuous development of silicon-based photonics, and especially, high-speed and high-bandwidth optical assemblies based on the silicon-based photonics are widely used and developed. To obtain better performance and a smaller size, packaging of an optical assembly relates to packaging of an optical chip and a fiber array unit (FAU). This obtains a co-packaged optics (CPO) module with a more compact structure.

A preparation process of the optical assembly relates to a process of side coupling between the FAU and a waveguide array in the optical chip. The side coupling process includes fastening and coupling the FAU to the optical chip using a glue. After being packaged, the optical assembly needs to undergo high-temperature reflow. Therefore, requirements of a low refractive index, high temperature resistance, and a high bonding strength are imposed on the glue. However, it is difficult for a current glue to meet all of the requirements, resulting in an unsatisfactory effect of coupling the FAU to the optical chip.

### SUMMARY

A first aspect of this application provides an optical assembly, including:
a fiber array unit, including a base plate and a plurality of optical fibers, where the plurality of optical fibers are located on a surface of the base plate, the plurality of optical fibers have optical fiber end faces, and a plane on which the optical fiber end faces are located is not perpendicular to a plane on which the surface of the base plate is located; and
an optical chip, including a substrate and a waveguide layer, where the substrate has a substrate end face, the waveguide layer is formed on a surface of the substrate, the waveguide layer has a waveguide end face, the substrate end face and the waveguide end face are at a non-zero included angle, and the optical fiber end faces are coupled to the waveguide end face.

In an embodiment, an optical fiber and a waveguide form a horizontal chamfer. Consequently, errors occurring when chamfers are formed are successively accumulated in a plurality of waveguides, resulting in an excessively large error of an entire waveguide layer. However, in the optical assembly provided in this application, the plane on which the optical fiber end faces are located is disposed to be not perpendicular to the plane on which the surface of the base plate is located, and the substrate end face and the waveguide end face are disposed to be at the non-zero included angle. In this way, the optical fiber and the waveguide layer can form a vertical chamfer to replace the horizontal chamfer. The optical fibers and waveguides are all formed in a same etching process. If an error exists, errors of the optical fibers and the waveguides are all consistent, and the errors are not accumulated. Therefore, in a manner of forming the vertical chamfer, the optical assembly helps reduce an alignment error between the optical fiber and the waveguide. This reduces a return loss caused after the optical fiber is coupled to the waveguide, and improves an effect of coupling the fiber array unit to the optical chip.

In some embodiments, the fiber array unit further includes a cover plate. The cover plate partially covers sides that are of the plurality of optical fibers and that are away from the base plate. The cover plate has a cover plate end face, and the cover plate end face and the optical fiber end faces are not on a same plane.

In this way, the optical fibers are disposed between the cover plate and the base plate, to help better fasten structures of the optical fibers, and protect the optical fibers. In addition, the cover plate end face and the optical fiber end faces are not on the same plane, so that a spacing exists between the optical fiber end faces and the cover plate end face. A plurality of “V”-shaped grooves are provided on the base plate to accommodate the optical fibers. The cover plate covers the sides that are of the optical fibers and that are away from the base plate. An area that is on the surface of the base plate and in which the V-shaped grooves are not provided is bonded to the cover plate using a third colloid (not shown in the figure). It can be learned from the foregoing structure that a first colloid is located between the waveguide end face and the optical fiber end faces and is in direct contact with the optical fiber end faces. If the cover plate extends to be connected to the optical fiber end faces, the third colloid between the base plate and the cover plate may be in contact with the first colloid. As a result, different material interfaces of the first colloid and the third colloid exist on the optical fiber end faces. The different material interfaces affect propagation of an optical signal in the optical fiber. The optical fiber end faces is disposed to be spaced from the cover plate end face, to avoid contact between the first colloid and the third colloid, thereby avoiding different material interfaces, helping ensure correct propagation of the optical signal in the optical fiber, and helping improve an effect of coupling the optical fiber to the waveguide.

In some embodiments, sides that are of the plurality of optical fibers and that are away from the base plate are exposed.

The fiber array unit does not include a cover plate, and the base plate does not need to be bonded and fastened to the cover plate using a third colloid. Therefore, there is not a problem that different material interfaces affect optical signal transmission. Therefore, it is unnecessary to dispose the optical fiber end faces to be spaced from the cover plate end face.

In some embodiments, the waveguide end face is connected to the substrate end face.

In some embodiments, the waveguide end face and the surface of the substrate form a step-shaped structure.

When the waveguide end face is connected to the substrate end face, a manner of forming the waveguide end face may not be limited to exposure and development, and may be another etching manner (for example, laser etching).

In some embodiments, the optical assembly further includes: the first colloid, located between the optical fiber end faces and the waveguide end face, and used to couple the fiber array unit to the waveguide layer; and a second colloid, located between the fiber array unit and the optical chip, and used to fasten the fiber array unit to the optical chip, where a material of the first colloid is different from that of the second colloid, and a bonding strength of the first colloid is less than a bonding strength of the second colloid.

The first colloid can be used to couple the optical fibers to the waveguides, and has features of a low refractive index and high temperature resistance. The second colloid can be used to fasten the fiber array unit to the optical chip, and has features of a high bonding strength and high temperature resistance. Therefore, in a subsequent high-temperature preparation process of the optical assembly, both the first colloid and the second colloid can maintain the features of the first colloid and the features of the second colloid. To be specific, the first colloid can maintain a refractive index that is of the first colloid and that matches a refractive index of a coating layer of the optical fiber, maintain the effect of coupling the optical fibers to the waveguides, and control the return loss. The second colloid can maintain the high bonding strength, so that the fiber array unit is firmly bonded to the optical chip. The first colloid and the second colloid that are made of different materials are separately used, so that the first colloid has the features of the low refractive index and high temperature resistance, and the second colloid has the features of the high bonding strength and high temperature resistance. In this way, a refractive index matching effect and a fastening effect are separately implemented using the first colloid and the second colloid, to resolve a technical problem that it is difficult to use one glue in the optical assembly to satisfy all of three features: the low refractive index, high temperature resistance, and the high bonding strength.

In some embodiments, a heat resistance of the second colloid is greater than that of the first colloid.

The fiber array unit can be fastened to the optical chip using the second colloid, and can be coupled to the optical chip using the first colloid. The heat resistance of the second colloid is greater than that of the first colloid, and a refractive index requirement on the first colloid can be effectively met. Even if the first colloid has a poor heat resistance due to the refractive index requirement, the fiber array unit can also be well fastened to the optical chip using the second colloid. Therefore, the heat resistance of the second colloid is set to be greater than that of the first colloid, to help improve the coupling effect while ensuring a bonding strength between the fiber array unit and the optical chip.

In some embodiments, the first colloid and the second colloid are spaced apart.

This helps prevent the first colloid and the second colloid from generating different material interfaces, thereby avoiding impact on optical signal propagation.

In some embodiments, the second colloid is located between the base plate and the optical chip, and is used to bond the base plate to the optical chip.

In this way, the fiber array unit is directly bonded to the optical chip using the second colloid, without an auxiliary bonding member.

In some embodiments, the optical assembly further includes an auxiliary bonding member. The auxiliary bonding member is separately bonded to the fiber array unit and the optical chip using the second colloid.

The auxiliary bonding member is separately bonded to the fiber array unit and the optical chip, so that the fiber array unit is fastened to the optical chip. The auxiliary bonding member is separately prepared, and a structure of the auxiliary bonding member is easy to change. If the base plate of the fiber array unit needs to be directly bonded to the optical chip, the base plate of the fiber array unit needs to be designed in a specific shape, and a preparation process is complex. Therefore, the auxiliary bonding member is separately bonded to the fiber array unit and the optical chip, to help simplify a structure of the base plate, so as to simplify a preparation process of the fiber array unit.

In some embodiments, the first colloid is silica gel; and/or the second colloid is an epoxy adhesive or an acrylic resin adhesive.

A coating layer of the waveguide is usually made of silicon dioxide. The first colloid is used as a colloid for coupling the waveguides to the optical fibers, and is the silicon gel. This facilitates refractive index matching. The epoxy adhesive and the acrylic resin adhesive have high heat resistances and bonding strengths, so that the second colloid can well adapt to the subsequent high-temperature preparation process of the optical assembly, and maintain the bonding strength between the fiber array unit and the optical chip.

A second aspect of this application provides an optical chip, including: a substrate, having a substrate end face; and a waveguide layer, formed on a surface of the substrate, where the waveguide layer has a waveguide end face, the substrate end face and the waveguide end face are at a non-zero included angle, the waveguide end face is configured to be coupled to an optical fiber end face of an optical fiber, the optical fiber is located on a surface of a base plate, and a plane on which the optical fiber end face is located is not perpendicular to a plane on which the surface of the base plate is located.

In an embodiment, an optical fiber and a waveguide form a horizontal chamfer. Consequently, errors occurring when chamfers are formed are successively accumulated in a plurality of waveguides, resulting in an excessively large error of an entire waveguide layer. However, in the optical chip, the substrate end face and the waveguide end face are set to be at the non-zero included angle. In this way, the waveguide layer can form a vertical chamfer to replace the horizontal chamfer. Waveguides in the waveguide layer are formed in a same etching process. If an error exists, errors of chambers of the waveguides are all consistent, and the errors are not accumulated. Therefore, in a manner of forming the vertical chamfer, when the waveguide in the optical chip is coupled to the optical fiber in a fiber array unit, the optical chip helps reduce an alignment error between the optical fiber and the waveguide. This reduces a return loss caused after the optical fiber is coupled to the waveguide, and improves an effect of coupling the fiber array unit to the optical chip.

In some embodiments, the waveguide end face is connected to the substrate end face.

In some embodiments, the waveguide end face and the surface of the substrate form a step-shaped structure.

When the waveguide end face is connected to the substrate end face, a manner of forming the waveguide end face may not be limited to exposure and development, and may be another etching manner (for example, laser etching).

A third aspect of this application provides an electronic device, including: a plurality of the optical assemblies according to any one of the first aspect, the embodiments of the first aspect, the second aspect, and the embodiments of the second aspect, where each of the optical assemblies is configured to output an interaction signal through the plurality of optical fibers and the waveguide layer; and a switching chip, separately connected to the plurality of the optical assemblies, and configured to establish communication between the plurality of the optical assemblies based on the interaction signal.

In an embodiment, an optical fiber and a waveguide form a horizontal chamfer. Consequently, errors occurring when chamfers are formed are successively accumulated in a plurality of waveguides, resulting in an excessively large error of an entire waveguide layer. However, the electronic device provided in this application includes the optical assemblies. In the optical assembly, a plane on which the optical fiber end faces are located is disposed to be not perpendicular to a plane on which the surface of the base plate is located, and the substrate end face and the waveguide end face are disposed to be at a non-zero included angle. In this way, the optical fiber and the waveguide layer can form a vertical chamfer to replace the horizontal chamfer. The optical fibers and the waveguides are all formed in a same etching process. If an error exists, errors of the optical fibers and the waveguides are all consistent, and the errors are not accumulated. Therefore, in a manner of forming the vertical chamfer, the optical assembly helps reduce an alignment error between the optical fiber and the waveguide. This reduces a return loss caused after the optical fiber is coupled to the waveguide, and improves an effect of coupling the fiber array unit to the optical chip.

A fourth aspect of this application provides an optical communication system, including a plurality of electronic devices that are in a communication connection. At least one of the electronic devices is the foregoing electronic device.

In an embodiment, an optical fiber and a waveguide form a horizontal chamfer. Consequently, errors occurring when chamfers are formed are successively accumulated in a plurality of waveguides, resulting in an excessively large error of an entire waveguide layer. However, the optical communication system provided in this application includes the electronic device, and the electronic device includes the optical assemblies. In the optical assembly, a plane on which the optical fiber end faces are located is disposed to be not perpendicular to a plane on which the surface of the base plate is located, and the substrate end face and the waveguide end face are disposed to be at a non-zero included angle. In this way, the optical fiber and the waveguide layer can form a vertical chamfer to replace the horizontal chamfer. The optical fibers and the waveguides are all formed in a same etching process. If an error exists, errors of the optical fibers and the waveguides are all consistent, and the errors are not accumulated. Therefore, in a manner of forming the vertical chamfer, the optical assembly helps reduce an alignment error between the optical fiber and the waveguide. This reduces a return loss caused after the optical fiber is coupled to the waveguide, and improves an effect of coupling the fiber array unit to the optical chip.

### BRIEF DESCRIPTION OF DRAWINGS

FIG. 1 is a diagram of a cross-sectional structure of an optical assembly according to an embodiment of this application;

FIG. 2 is a diagram of a plane structure of a fiber array unit in an optical assembly according to an embodiment of this application;

FIG. 3 is a diagram of a plane structure of an optical chip in an optical assembly according to an embodiment of this application;

FIG. 4 is a diagram of another cross-sectional structure of an optical assembly according to an embodiment of this application;

FIG. 5 is a diagram of a cross-sectional structure of an optical assembly according to a changed embodiment of this application;

FIG. 6 is a diagram of a cross-sectional structure of an optical assembly according to another changed embodiment of this application;

FIG. 7 is a diagram of a structure of an electronic device according to an embodiment of this application; and

FIG. 8 is a diagram of a plane structure obtained when an FAU is coupled to an optical chip in an embodiment.

### DETAILED DESCRIPTION

The following describes embodiments of this application with reference to the accompanying drawings in embodiments of this application.

It should be noted that same reference numerals in the accompanying drawings of this application denote same or similar structures. Therefore, repeated descriptions thereof are omitted. Words that express a position and a direction and that are described in this application are all descriptions provided by using the accompanying drawings as examples, but changes may alternatively be made as required, and all the made changes fall within the protection scope of this application. The accompanying drawings in this application are used merely to illustrate a relative position relationship and do not represent an actual scale.

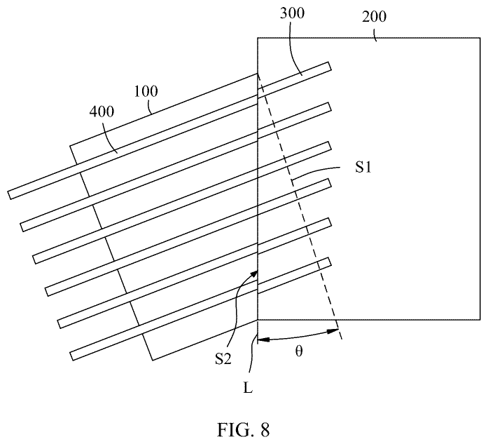

In an embodiment, a preparation process of an optical assembly relates to a process of side coupling between an FAU and a waveguide array in an optical chip. Refer to FIG. 8. The side coupling process includes fastening and coupling an FAU 100 to an optical chip 200 using a glue.

In one aspect, to reduce a return loss, waveguides 300 in the optical chip 200 need to match optical fibers 400 in the FAU 100 at a specific angle. In other words, on a horizontal plane (a plane on which the waveguides 300 and the optical fibers 400 in FIG. 8 are located), extension directions of the waveguides 300 and the optical fibers 400 are tilted relative to a coupling end face S2. At an early stage of processing, the extension directions of the optical fibers 400 are perpendicular to an initial end face S1 of the FAU 100. The FAU 100 is etched along a cutting line L, so that the coupling end face S2 is formed on an etched FAU 100. The optical fibers 400 are tilted relative to the coupling end face S2. Correspondingly, in a photoetching process, the waveguides 300 are also at a tilt angle corresponding to the optical fibers 400, to facilitate coupling. The foregoing process of etching the FAU 100 is defined as forming a horizontal chamfer θ (that is, the optical fibers 400 and the coupling end face S2 are at a horizontal angle on the horizontal plane). When the optical fibers 400 are coupled to the waveguides 300, the optical fibers 400 are in a one-to-one correspondence with the waveguides 300. An optical fiber 400 and a waveguide 300 that are located in a middle position are first aligned, and then optical fibers 400 and waveguides 300 that are located on two sides are in a one-to-one correspondence.

In this embodiment, when an error exists in the horizontal chamfer θ (when the error exists in θ, the cutting line L in FIG. 8 deviates to the left or right), a position of an end face of each optical fiber 400 deviates. In addition, because the optical fiber 400 and the waveguide 300 that are in the middle position are first aligned, optical fibers 400 that are closer to the two sides have end faces whose positions deviate more greatly, and have larger alignment errors with optical fibers 300. As a quantity of channels (one channel includes one waveguide 300 and one optical fiber 400 coupled to the waveguide 300) of the optical assembly continuously increases, the error of the horizontal chamfer θ causes an increase of an alignment error between the optical fiber 400 and the waveguide 300. Then, the increase of the foregoing error causes deterioration of consistency between coupling losses of different channels. For example, an extra loss of 0.7 dB to 2.5 dB is introduced in 72 channels due to a chamfer tolerance of 0.3°.

Embodiments of this application provide an optical assembly, a fiber array unit, an optical chip, an electronic device, and an optical communication system, to resolve the foregoing technical problem that the error of the horizontal chamfer causes the return loss.

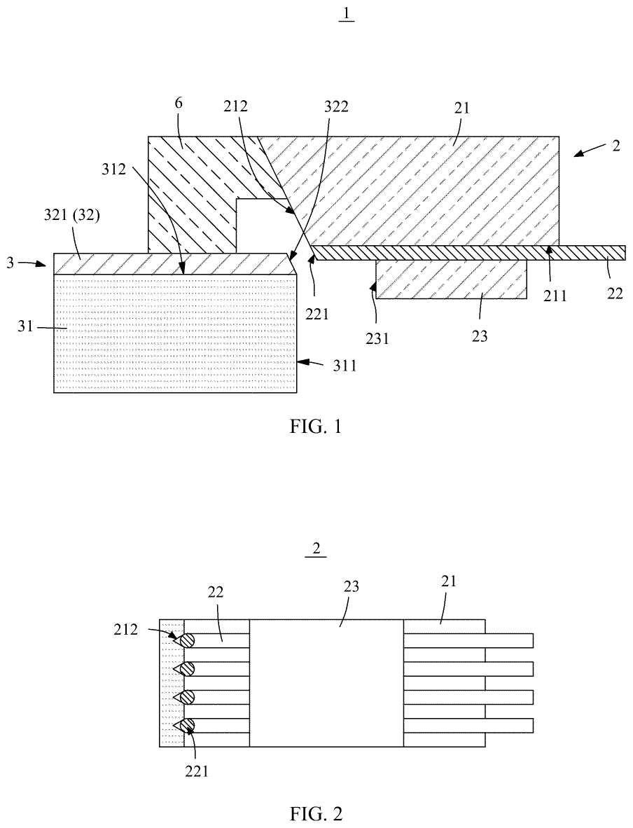

Refer to FIG. 1. An optical assembly 1 in an embodiment of this application is a co-packaged optics structure, and includes a fiber array unit 2 and an optical chip 3. The fiber array unit 2 and the optical chip 3 are fastened and coupled to each other, so that an optical signal can be transmitted between the fiber array unit 2 and the optical chip 3.

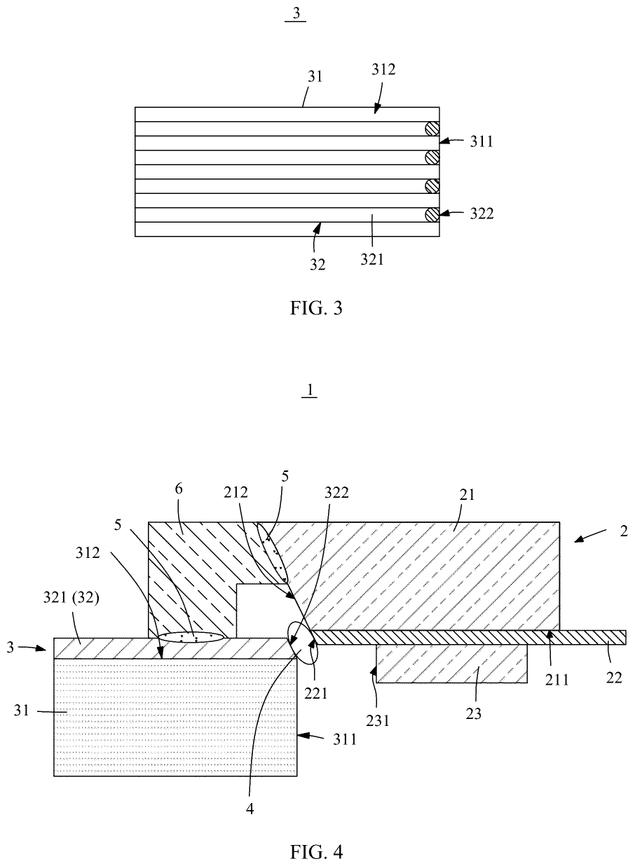

Refer to FIG. 1 to FIG. 3 together. The fiber array unit 2 includes a base plate 21, a plurality of optical fibers 22, and a cover plate 23. The base plate 21 has a surface 211, each optical fiber 22 is located on the surface 211 of the base plate 21, and the optical fibers 22 are arranged in parallel and spaced apart. The cover plate 23 partially covers a side that is of each optical fiber 22 and that is away from the base plate 21. To be specific, each optical fiber 22 is located between the base plate 21 and the cover plate 23, and an end that is of each optical fiber 22 and that is configured to be coupled to the optical chip 3 is exposed relative to the cover plate 23. The base plate 21 is used as a substrate for bearing the optical fibers 22. Each optical fiber 22 is configured to transmit an optical signal. The cover plate 23 and the base plate 21 are configured to jointly fasten and protect the optical fibers 22. In this embodiment, both the base plate 21 and the cover plate 23 are glass.

The optical chip 3 includes a structure for transmitting an optical signal, and may be further integrated with a structure configured to transmit an electrical signal. In this embodiment of this application, the structure for transmitting the optical signal in the optical chip 3 is described.

In this embodiment, the optical chip 3 includes a substrate 31 and a waveguide layer 32. The substrate 31 has an upper surface 312, and the waveguide layer 32 is located on the upper surface 312 of the substrate 31. The waveguide layer 32 includes a plurality of waveguides 321 (referring to FIG. 2), and the waveguides 321 are arranged in parallel and spaced apart. Each waveguide 321 is configured to transmit an optical signal. In this embodiment, the optical fibers 22 are coupled to the waveguides 321 in a one-to-one correspondence, to implement optical signal transmission between the optical fibers 22 and the waveguides 321.

When the optical assembly 1 is assembled, the fiber array unit 2 needs to be coupled to the optical chip 3. In this embodiment, coupling the fiber array unit 2 to the optical chip 3 mainly includes coupling the optical fibers 22 to the waveguides 321. In the comparative example, when the optical fibers are coupled to the waveguides, it is difficult to reduce the return loss due to the error. In this application, angle matching between the optical fibers 22 and the waveguides 321 is improved, to reduce a return loss.

In this embodiment of this application, each optical fiber 22 has an optical fiber end face 221. Each waveguide 321 has a waveguide end face 322. The optical fiber end faces 221 and the waveguide end faces 322 are disposed in a one-to-one correspondence and coupled.

In the fiber array unit 2, the base plate 21 has a base plate end face 212 facing the optical chip 3, and the cover plate 23 has a cover plate end face 231 facing the optical chip 3. The optical fiber end faces 221 and a plane on which the surface 211 of the base plate 21 is located are at a non-90° included angle, that is, form a slope. In addition, in this embodiment, the base plate end face 212 of the base plate 21 and the optical fiber end faces 221 are on a same plane. At an early stage of processing, the base plate end face 212 and the optical fiber end faces 221 are all perpendicular to the plane on which the surface 211 is located. In a subsequent preparation process, the base plate 21 and the optical fibers 22 are etched together to form shapes of the base plate end face 212 and the optical fiber end faces 221 shown in FIG. 1 and FIG. 2.

Corresponding to that in the fiber array unit 2, in the optical chip 3, each waveguide 321 has the waveguide end face 322, and the substrate 31 has a substrate end face 311. The substrate end face 311 extends perpendicular to the upper surface 312. The waveguide end faces 322 and the substrate end face 311 have a non-zero included angle. To be specific, the waveguide end faces 322 and the substrate end face 311 are not located on a same plane, so that the waveguide end faces 322 form a slope structure.

Tilt directions of the optical fiber end faces 221 are approximately parallel to those of the waveguide end faces 322, to facilitate coupling between the optical fiber end faces 221 and the waveguide end faces 322.

On a vertical plane (a plane perpendicular to a plane on which the waveguides 321 are located), a structure of the optical fiber end faces 221 and the waveguide end faces 322 that is shown in FIG. 1 and the substrate end face 311 are at a non-90° included angle that is defined as a vertical chamfer in this embodiment of this application. This helps reduce the return loss caused after the optical fibers 22 are coupled to the waveguides 321.

In the foregoing comparative example, the optical fibers 400 and the waveguides 300 are at the horizontal chamfer. Consequently, errors of the optical fibers 400 gradually accumulate from the middle position to the two sides, and consistency between losses of the channels deteriorates. However, in this embodiment of this application, the vertical chamfer is formed to replace the horizontal chamfer. Even if an error exists in a process of forming the chamfer, impact of errors of chamfers on the optical fibers 22 is consistent. To be specific, the errors of the chamfers of the optical fibers 22 are consistent, and the errors are not accumulated. Therefore, in this embodiment of this application, forming the vertical chamfer helps reduce an alignment error between the optical fibers 22 and the waveguides 321, to reduce the return loss caused after the optical fibers 22 are coupled to the waveguides 321, improve consistency between the losses of the channels, and improve an effect of coupling the optical fibers 22 to the waveguides 321.

In another aspect, in the foregoing comparative example, a surface-mount technology (SMT) is applied to the optical assembly. Consequently, the optical assembly needs to undergo a high temperature of more than 260° C. in a reflow oven. Refer to FIG. 8 again. A glue for bonding the FAU 100 to the optical chip 200 needs to undergo high temperature reflow at 260° C. To reduce an insertion loss, when the optical fiber 400 in the FAU 100 is coupled to the waveguide 300 in the optical chip 200, a glue whose refractive index matches a refractive index of a material of a coating layer of the waveguide 300 (the waveguide 300 usually has the wrapping layer) needs to be filled. Because SiO2 is a quite typical material of the wrapping layer, a glue with a low refractive index is usually required.

It can be learned that the glue needs to have all of three features: the low refractive index, high temperature resistance, and a sufficient bonding strength, but it is quite difficult to meet all of the foregoing three requirements. In a coupling embodiment in the conventional technology, after high temperature reflow at 260° C., the glue on a bonding surface between the FAU and the optical chip has an obvious defect, and bonding force greatly decreases. This increases a loss of the optical assembly and a reliability risk of the optical assembly.

The optical assembly 1 provided in this embodiment of this application is further configured to resolve the foregoing technical problem of the glue.

Refer to FIG. 4. In this embodiment of this application, the optical assembly 1 further includes a first colloid 4. The first colloid 4 is located between the optical fiber end faces 221 and the waveguide end faces 322, is in direct contact with the optical fiber end faces 221 and the waveguide end faces 322, and is used to couple the optical fiber end faces 221 to the waveguide end faces 322. Each optical fiber 22 includes a fiber core and a coating layer (not shown in the figure) that wraps the fiber core. A refractive index of the first colloid 4 matches that of a material of the coating layer of the optical fiber 22. The first colloid 4 further is viscous, and may be used to fasten the optical fibers 22 to the waveguides 321.

In this embodiment, the optical assembly 1 further includes a second colloid 5 and an auxiliary bonding member 6. In this embodiment, the auxiliary bonding member 6 is glass. One end of the auxiliary bonding member 6 is connected to the fiber array unit 2, and the other end of the auxiliary bonding member 6 is connected to the optical chip 3. The second colloid 5 is filled between the fiber array unit 2 and the auxiliary bonding member 6, and the second colloid 5 is also filled between the optical chip 3 and the auxiliary bonding member 6. The second colloid 5 is used to bond the fiber array unit 2 to the auxiliary bonding member 6, and is further used to bond the optical chip 3 to the auxiliary bonding member 6. In other words, the auxiliary bonding member 6 is separately bonded to the fiber array unit 2 and the optical chip 3 using the second colloid 5, so that the fiber array unit 2 and the optical chip 3 are fastened to each other. In an embodiment, the end of the auxiliary bonding member 6 is connected to the base plate 21 of the fiber array unit 2, and the other end of the auxiliary bonding member 6 is connected to a side that is of the optical chip 3 and that has the waveguide layer 32.

In another embodiment, the optical assembly 1 may not include the auxiliary bonding member 6. The base plate 21 of the fiber array unit 2 extends reversely toward the optical chip 3 to form a connection part having a same structure as the auxiliary bonding member 6. The second colloid 5 is filled between the optical chip 3 and an end part that is of the connection part and that is close to the optical chip 3, to directly fasten the base plate 21 to the optical chip 3. In this way, the auxiliary bonding member 6 does not need to be additionally prepared.

The first colloid 4 can be used to couple the optical fibers 22 to the waveguides 321, and has features of a low refractive index and high temperature resistance. In this embodiment, the refractive index of the first colloid 4 matches that of the coating layer of the waveguide 321, and the refractive index is less than or equal to 1.44. To adapt to a subsequent high-temperature preparation process of the optical assembly, the first colloid 4 resists at least a high temperature of 260° C. The second colloid 5 can be used to fasten the fiber array unit 2 to the optical chip 3, and has features of a high bonding strength and high temperature resistance. Therefore, in the subsequent high-temperature preparation process of the optical assembly 1, both the first colloid 4 and the second colloid 5 can maintain the features of the first colloid 4 and the features of the second colloid 5. To be specific, the first colloid 4 can maintain a feature that the refractive index of the first colloid 4 matches the refractive index of the coating layer of the optical fiber 22, to maintain the effect of coupling the optical fibers 22 to the waveguides 321, and control the return loss. The second colloid 5 can maintain the high bonding strength, so that the fiber array unit 2 is firmly bonded to the optical chip 3.

In this embodiment, a heat resistance of the second colloid 5 is greater than that of the first colloid 4. The fiber array unit 2 can be fastened to the optical chip 3 using the second colloid 5, and can be coupled to the optical chip 3 using the first colloid 4. The heat resistance of the second colloid 5 is greater than that of the first colloid 4, and a refractive index requirement on the first colloid 4 can be limitedly met. Even if the first colloid 4 has a poor heat resistance due to the refractive index requirement, the fiber array unit 2 can also be well fastened to the optical chip 3 using the second colloid 5. Therefore, the heat resistance of the second colloid 5 is set to be greater than that of the first colloid 4, to help improve the coupling effect while ensuring a bonding strength between the fiber array unit 2 and the optical chip 3.

In this embodiment, the first colloid 4 is silica gel, and the second colloid 5 is an epoxy adhesive or an acrylic resin adhesive.

To be specific, in this embodiment, the first colloid 4 and the second colloid 5 that are made of different materials are separately used, so that the first colloid 4 has the features of the low refractive index and high temperature resistance, and the second colloid 5 has the features of the high bonding strength and high temperature resistance. In this way, a refractive index matching effect and a fastening effect are separately implemented using the first colloid 4 and the second colloid 5, to resolve a technical problem that, when one glue is used to couple and fasten the optical chip to the fiber array unit in the optical assembly, it is difficult to satisfy all of the three features: the low refractive index, high temperature resistance, and the high bonding strength.

In this embodiment, because the first colloid 4 and the second colloid 5 are respectively used to implement the coupling effect and the fastening effect, the effects of coupling and fastening the fiber array unit 2 to the optical chip 3 in the optical assembly 1 are both improved.

Further, in this embodiment, the optical fiber end face 221 and the waveguide end face 322 are set to have the vertical chamfer. Therefore, an embodiment of angle matching between the optical fiber 22 and the waveguide 321 is changed, and the return loss for the optical fiber 22 and the waveguide 321 is significantly reduced. This reduces sensitivity of the first colloid 4 to the return loss, thereby helping expand a selection range of a material of the first colloid 4. To be specific, in the comparative example, the horizontal chamfer is used. Consequently, an effect of coupling the optical fiber to the waveguide is poorer, and the return loss is higher. In this case, only a glue made of some specific materials can be used to implement refractive index matching, and meet a requirement of coupling the optical fiber to the waveguide. However, in this embodiment, because the vertical chamfer is used, the effect of coupling the optical fiber 22 to the waveguide 321 is significantly improved, and the return loss caused after the optical fiber 22 is coupled to the waveguide 321 is significantly reduced. In this case, selection of the material of the first colloid 4 can be appropriately relaxed, and a requirement of coupling the optical fiber 22 to the waveguide 321 can also be met. Therefore, in this embodiment, the vertical chamfer is used for the optical fiber 22 and the waveguide 321. This further helps expand the selection range of the material of the first colloid 4.

In this embodiment, the cover plate 23 has a cover plate end face 231. The cover plate end face 231 is perpendicular to the plane on which the surface 211 of the base plate 21 is located. In addition, in a horizontal direction (using FIG. 4 as a reference), a spacing exists between the optical fiber end face 221 and the cover plate end face 231. To be specific, the optical fiber end face 221 and the cover plate end face 231 are not on a same plane and are not interconnected.

Refer to FIG. 2 again. In this embodiment, a plurality of “V”-shaped grooves are provided on the base plate 21 to accommodate the optical fibers 22. The cover plate 23 covers the sides that are of the optical fibers 22 and that are away from the base plate 21. An area that is on the surface 211 of the base plate 21 and in which the V-shaped grooves are not provided is bonded to the cover plate 23 using a third colloid (not shown in the figure). It can be learned from the foregoing structure that the first colloid 4 is located between the waveguide end face 322 and the optical fiber end faces 221 and is in direct contact with the optical fiber end faces 221. Refer to FIG. 4 again. If the cover plate 23 extends to be connected to the optical fiber end faces 221, the third colloid between the base plate 21 and the cover plate 23 may be in contact with the first colloid 4. As a result, different material interfaces of the first colloid 4 and the third colloid exist on the optical fiber end faces 221. The different material interfaces affect propagation of an optical signal in the optical fiber.

Therefore, in this embodiment of this application, the optical fiber end faces 221 is disposed to be spaced from the cover plate end face 231, to avoid contact between the first colloid 4 and the third colloid, thereby avoiding different material interfaces, helping ensure correct propagation of the optical signal in the optical fiber 22, and helping improve the effect of coupling the optical fiber 22 to the waveguide 321.

In this embodiment, the auxiliary bonding member 6 is approximately an “L”-shaped structure, so that the end that is of the auxiliary bonding member 6 and that is connected to the fiber array unit 2 is far away from the first colloid 4 as far as possible. This avoids impact on optical signal transmission due to different material interfaces generated when the first colloid 4 is in contact with the second colloid 5. In other words, the auxiliary bonding member 6 spaces the first colloid 4 from the second colloid 5. In another embodiment, the auxiliary bonding member 6 may be another structure, for example, an arc, provided that the foregoing effect can be achieved.

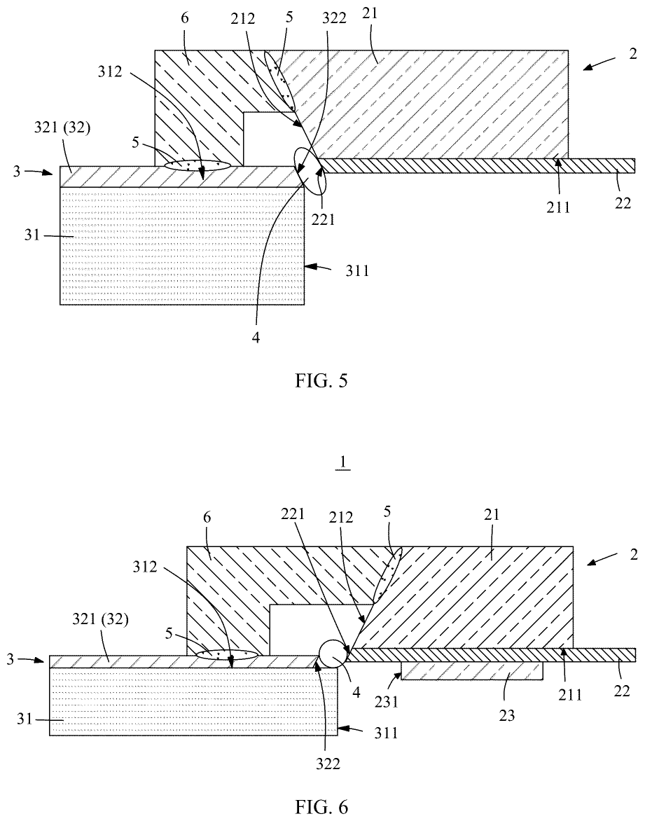

Refer to FIG. 5. In a changed embodiment of this application, the fiber array unit 2 does not include a cover plate 23, that is, a side that is of each optical fiber 22 and that is away from the base plate 21 is exposed. In the changed embodiment, the fiber array unit 2 does not include the cover plate 23, and the base plate 21 does not need to be bonded and fastened to the cover plate 23 using a third colloid. Therefore, there is not a problem that different material interfaces affect optical signal transmission. Therefore, it is unnecessary to dispose the optical fiber end face 221 to be spaced from the cover plate end face 231.

Refer to FIG. 6. In another changed embodiment of this application, a manner of forming a vertical chamfer may be different from the manner shown in FIG. 1 to FIG. 5.

In the changed embodiment, tilt directions of the optical fiber end face 221 and the base plate end face 212 are different from the slope structure shown in FIG. 1 to FIG. 5. Correspondingly, a tilt direction of the waveguide end face 322 is also different from the slope structure shown in FIG. 1 to FIG. 5, and is approximately parallel to the optical fiber end face 221 and the base plate end face 212. This facilitates coupling between the optical fiber 22 and the waveguide 321.

In this embodiment, because the tilt direction of the waveguide end face 322 changes, the waveguide end face 322 is not connected to the substrate end face 311, and the waveguide end face 322 and the substrate end face 311 form a step-shaped structure. The first colloid 4 is located at the step-shaped structure.

In the changed embodiment shown in FIG. 6, because the tilt direction of the waveguide end face 322 changes, a manner of forming the waveguide end face 322 in the optical chip 3 needs to be an etching manner of exposure and development.

In the changed embodiment shown in FIG. 6, a structure of the optical assembly 1 is also applicable to a case in which the fiber array unit 2 does not include the cover plate 23.

In this application, all of the foregoing changed embodiments can be used to achieve all beneficial effect in the embodiments shown in FIG. 1 to FIG. 4.

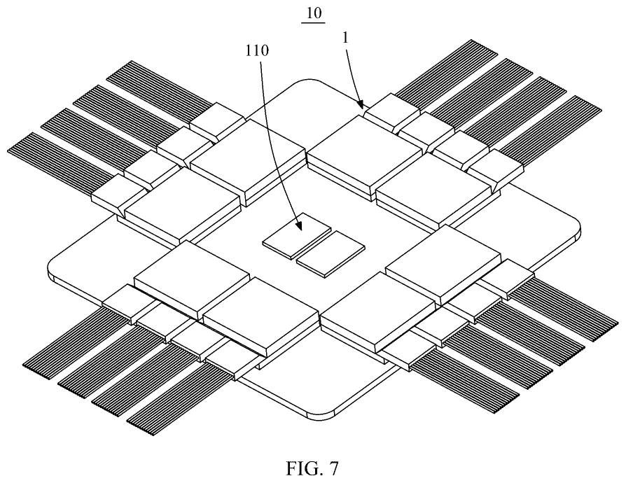

Refer to FIG. 7. Based on a same technical concept, an embodiment of this application further provides an electronic device 10. The electronic device 10 includes one or more of the foregoing optical assemblies 1, and further includes a switching chip 110 connected to the optical assembly 1. Each optical assembly 1 is configured to output an interaction signal through the optical fiber and the waveguide. The switching chip 110 is connected to each optical assembly 1, and is configured to establish communication between the plurality of the foregoing optical assemblies based on the interaction signal. The electronic device 10 may be a telecommunication machine room, a data center, a router, a switch, a server, or the like. The optical assembly 1 may also be used in another type of electronic device. This is not limited in this application.

This embodiment further provides an optical communication system. The optical communication system includes a plurality of electronic devices. At least one electronic device is the electronic device 10 in this embodiment of this application. The electronic devices are in a communication connection, to implement information and data exchange. In the optical communication system in this embodiment, because the electronic device 10 is used, and the electronic device 10 includes the optical assembly 1, reliability is high and a loss is low.

A person of ordinary skill in the art should be aware that the foregoing embodiments are merely used to describe the present application, but are not intended to limit the present application. Appropriate modifications and variations made to the foregoing embodiments shall fall within the protection scope of the present application provided that the modifications and variations fall within the substantive scope of the present application.

1. An optical assembly, comprising:
a fiber array unit comprising a base plate and a plurality of optical fibers located on a surface of the base plate, wherein the plurality of optical fibers have optical fiber end faces, and a plane on which the optical fiber end faces are located is not perpendicular to a plane on which the surface of the base plate is located; and
an optical chip comprising a substrate and a waveguide layer, wherein the substrate has a substrate end face, the waveguide layer is formed on a surface of the substrate, the waveguide layer has a waveguide end face, the substrate end face and the waveguide end face are at a non-zero included angle, and the optical fiber end faces are coupled to the waveguide end face.

2. The optical assembly according to claim 1, wherein the fiber array unit further comprises a cover plate that
partially covers sides of the plurality of optical fibers that are away from the base plate, the cover plate has a cover plate end face that is not on a same plane as the optical fiber end faces.

3. The optical assembly according to claim 1, wherein sides of the plurality of optical fibers away from the base plate are exposed.

4. The optical assembly according to claim 1, wherein the waveguide end face is connected to the substrate end face.

5. The optical assembly according to claim 1, wherein the waveguide end face and the surface of the substrate form a step-shaped structure.

6. The optical assembly according to claim 1, further comprising:
a first colloid located between the optical fiber end faces and the waveguide end face, and used to couple the fiber array unit to the waveguide layer; and
a second colloid located between the fiber array unit and the optical chip, and used to fasten the fiber array unit to the optical chip;
wherein a material of the first colloid is different from a material of the second colloid, and a bonding strength of the first colloid is less than a bonding strength of the second colloid.

7. The optical assembly according to claim 6, wherein a heat resistance of the second colloid is greater than a heat resistance of the first colloid.

8. The optical assembly according to claim 6, wherein the first colloid and the second colloid are spaced apart.

9. The optical assembly according to claim 6, wherein the second colloid is located between the base plate and the optical chip, and is used to bond the base plate to the optical chip.

10. The optical assembly according to claim 6, further comprising an auxiliary bonding member separately bonded to the fiber array unit and the optical chip using the second colloid.

11. The optical assembly according to claim 6, wherein the first colloid is silica gel; or the second colloid is an epoxy adhesive or an acrylic resin adhesive.

12. An optical chip, comprising:
a substrate having a substrate end face; and
a waveguide layer formed on a surface of the substrate, wherein the waveguide layer has a waveguide end face, the substrate end face and the waveguide end face are at a non-zero included angle, the waveguide end face is configured to be coupled to an optical fiber end face of an optical fiber that is located on a surface of a base plate, and a plane on which the optical fiber end face is located is not perpendicular to a plane on which the surface of the base plate is located.

13. The optical chip according to claim 12, wherein the waveguide end face is connected to the substrate end face.

14. The optical chip according to claim 12, wherein the waveguide end face and the surface of the substrate form a step-shaped structure.

15. An electronic device, comprising:
a plurality of optical assemblies, wherein each of the plurality of optical assemblies comprises:
a fiber array unit comprising a base plate and a plurality of optical fibers located on a surface of the base plate, wherein the plurality of optical fibers have optical fiber end faces, and a plane on which the optical fiber end faces are located is not perpendicular to a plane on which the surface of the base plate is located;
an optical chip comprising a substrate and a waveguide layer, wherein the substrate has a substrate end face, the waveguide layer is formed on a surface of the substrate, the waveguide layer has a waveguide end face, the substrate end face and the waveguide end face are at a non-zero included angle, and the optical fiber end faces are coupled to the waveguide end face, wherein each of the plurality of optical assemblies is configured to output an interaction signal through the plurality of optical fibers and the waveguide layer; and
a switching chip separately connected to the plurality of the optical assemblies, and configured to establish communication between the plurality of the optical assemblies based on the respective interaction signals.
